(19) United States
(12) Patent Application Publication
(10) Pub. No.: US 2009/0300861 A1
(43) Pub. Date: Dec. 10, 2009

(54) DISLOCATION PREVENTING BOLT, AND LONGITUDINAL RIB COMPOSITE FLOOR PANEL HAVING THE DISLOCATION PREVENTING BOLT

(76) Inventors: Yasumiki Yamamoto, Tokyo (JP); Kazuo Komori, Tokyo (JP); Atsunori Kawabata, Toyotake Kaga (JP); Tatsuya Matsumura, Tokyo (JP)

Correspondence Address: LADAS & PARRY LLP, 26 WEST 61ST STREET, NEW YORK, NY, 10023, US

(21) Appl. No.: 12/297,370

(22) PCT Filed: Sep. 3, 2007
(86) PCT No.: PCT/JP2007/067115

§ 371 Date: Feb. 3, 2009

(30) Foreign Application Priority Data
Sep. 8, 2006 (JP) 2006 244341

(51) Int. Cl. E01D 19/12; F16B 35/00

(52) U.S. Cl. 14/73; 411/386

(57) ABSTRACT

An object of the invention is to obtain dislocation preventing means which has a simple structure and reliably prevents dislocation from concrete, and cause a deck plate to correspond to a resistance cross section with respect to all dead/live loads over the entire length of a bridge beam. A dislocation preventing bolt 9 has a threaded section 91, having an external thread formed thereon, a tapered section 92, which is formed continuously from the threaded section, and a circular cylindrical section 93, which is formed continuously from the tapered section. A longitudinal rib composite floor slab 100 includes a main girder 1, a transverse girder 2 joined to the main girder 1, a deck plate 4 whose lower surface side is joined to the main girder 1 and the transverse girder 2, a longitudinal rib joined to the upper surface of the deck plate 4, concrete 7 placed on the upper surface of the deck plate 4, and pavement 5 placed on the upper surface of the concrete 7. The longitudinal rib 3 is provided with a plurality of through holes 31. A plurality of the dislocation preventing bolts 9 are inserted into the through holes 31, and are secured by nuts 99 through washers 98 so that they are incapable of coming off.

### TECHNICAL FIELD

The present invention relates to a dislocation preventing bolt and a longitudinal rib composite floor slab including the dislocation preventing bolt. More particularly, the present invention relates to a dislocation preventing bolt that prevents dislocation from concrete, and to a longitudinal rib composite floor slab of a road bridge, including the dislocation preventing bolt.

### BACKGROUND ART

FIGS. 8 and 9 are each a schematic view of the structure of a conventional composite floor slab of a road bridge. FIG. 8 is a perspective view, and FIG. 9 is a partial front view. In FIGS. 8 and 9, a composite floor slab 900 of a road bridge (hereunder simply referred to as the “composite floor slab”) comprises a lower structure and a superstructure work, which is supported by the lower structure. The lower structure comprises a main girder 1 and a transverse girder 2. The main girder 1 is parallel to a bridge axis indicated by an arrow. The horizontal girder 2 is joined to the main girder 1 (in the figures, a joint is represented by a weld line W12).

The superstructure work comprises a deck plate 4, upper-surface transverse ribs 20, concrete 7, and pavement 5. The upper-surface transverse ribs 20 are joined to the upper surface of the deck plate 4. The concrete 7 is placed on the upper surface of the deck plate 4. The pavement 5 is placed on the upper surface of the concrete 7. In the concrete 7, longitudinal reinforcing steel bars 81 are disposed in parallel to the bridge axis, and transverse reinforcing steel bars 82 are disposed perpendicularly to the bridge axis.

Dislocation preventing units (studs) 90 are joined to an upper flange 10 of the main girder 1. Haunch concrete 70 is placed on the upper surface of the upper flange 10. The deck plate 4 is placed on the haunch concrete 70. That is, the haunch concrete 70 is joined to the upper flange 10 of the main girder 1 through the dislocation preventing units 90, while the superstructure work is only placed on the haunch concrete 70. (Refer to, for example, Non-Patent Document 1.)

Non-Patent Document 1: “Steel Structure Design Policy” version; published by Japan Society of Civil Engineers), PART B, Composite Structure, p. 73

### DISCLOSURE OF INVENTION

### Problems to be Solved by the Invention

However, in the invention disclosed in the Non-Patent Document 1, the superstructure work is only placed on the haunch concrete 70. Therefore, in terms of the function of each member in view of the entire composite floor slab, the deck plate 4 is partly limited in the longitudinal direction of a bridge beam to a resistance cross section with respect to some dead loads, so that the concrete 7 is included in a resistance cross section with respect to a live load. Therefore, the load on the main girder 1 is increased, thereby increasing the amount of steel of the main girder 1.

To overcome such a problem, the applicant of the present application has already disclosed a composite floor slab structure (called “longitudinal rib composite floor slab”) which can cause a deck plate and a longitudinal rib, which is parallel to a bridge axis and joined to the upper surface side of the deck plate, to correspond to a resistance cross section with respect to all dead/live loads over the entire length of a bridge beam (refer to Japanese Patent Application No. 2005-303587).

The present invention can overcome the aforementioned problems, and its object is to make it possible to obtain dislocation preventing means, which reliably prevents dislocation from concrete in the aforementioned longitudinal rib composite floor and which has a simple structure, and a longitudinal rib composite floor slab including the dislocation preventing means.

### Means for Solving the Problems

(1) A dislocation preventing bolt according to the present invention prevents dislocation between concrete and a member surrounded by the concrete, and comprises:

a threaded section having an external thread formed thereon, a tapered section that is formed continuously from the threaded section and that is gradually enlarged, and a circular cylindrical section that is formed continuously from the tapered section.

(2) A longitudinal rib composite floor slab according to the present invention comprises:

a main girder that is parallel to a bridge axis;

a transverse girder that is joined to the main girder and that is perpendicular to the bridge axis;

a deck plate whose lower surface side is joined to the transverse girder;

a longitudinal rib that is joined to an upper surface side of the deck plate and that is parallel to the bridge axis; concrete that is placed on the upper surface of the deck plate; and

pavement that is placed on an upper surface of the concrete,

wherein the longitudinal rib is provided with a through hole, and

wherein the tapered section of the dislocation preventing bolt of the aforementioned (1) is retained by the through hole.

(3) A longitudinal rib composite floor slab comprises:

a main girder that is parallel to a bridge axis;

a transverse girder that is joined to the main girder and that is perpendicular to the bridge axis;

a deck plate whose lower surface side is joined to the transverse girder;

a longitudinal rib that is joined to an upper surface side of the deck plate and that is parallel to the bridge axis; concrete that is placed on the upper surface of the deck plate; and

a pavement that is placed on an upper surface of the concrete,

wherein the upper surface of the deck plate is provided with a stud dowel.

(4) In the aforementioned (2) or (3), the deck plate is joined to the main girder.

(5) In any one of the aforementioned (2) to (4), a side edge of the deck plate is provided with an outside stringer that is parallel to the bridge axis.

### Advantages

(i) Since the dislocation preventing bolt according to the present invention comprises a threaded section, a gradually tapering tapered section, and a cylindrical section, the structure is simple. In addition, if a through hole is formed in a member to set it, it is possible to insert the threaded section into the through hole and retain the tapered section. Therefore, construction is facilitated, and a desired dislocation preventing effect is obtained.

(ii) In the longitudinal rib composite floor slab according to the present invention, since the transverse girder is joined to the lower surface side of the deck plate, and the transverse girder is joined to the main girder, the deck plate and the main girder are dynamically connected to each other. Accordingly, the deck plate can correspond to a resistance cross section with respect to all dead/live loads over the entire length of a bridge beam. In particular, the longitudinal rib is joined to the upper surface side of the deck plate, and the dislocation preventing bolt is provided to the longitudinal rib, so that the rigidity and the reliability of the superstructure work are increased.

(iii) In addition, the longitudinal rib is joined to the upper surface side of the deck plate, and the stud dowel is provided at the upper surface of the deck plate, instead of the dislocation preventing bolt provided to the longitudinal rib. Therefore, the rigidity and the reliability of the superstructure work are increased.

(iv) Further, if the deck plate is directly joined to the main girder, or an outside stringer is provided at a side edge of the deck plate, or a protrusion is provided on the longitudinal rib, the aforementioned effects become notable.

### BRIEF DESCRIPTION OF DRAWINGS

FIG. 1 is a side view of a dislocation preventing bolt according to a first embodiment of the present invention.

FIG. 2 is a schematic perspective view of a longitudinal rib composite floor slab according to a second embodiment of the present invention.

FIG. 3 is a schematic partial front view of the longitudinal rib composite floor slab according to the second embodiment of the present invention.

FIG. 4 is a schematic partial enlarged view of the longitudinal rib composite floor slab according to the second embodiment of the present invention.

FIG. 5 is a partial front view showing a state in which the dislocation preventing bolts of the longitudinal rib composite floor slab shown in FIG. 2 are set.

FIG. 6 is a schematic partial enlarged view of a longitudinal rib composite floor slab according to a third embodiment of the present invention.

FIG. 7 is a partial front view showing a state in which stud dowels of the longitudinal rib composite floor slab shown in FIG. 6 are set.

FIG. 8 is a schematic perspective view of the structure of a conventional composite floor slab of a road bridge.

FIG. 9 is a schematic partial front view of the structure of the conventional composite floor slab of the road bridge.

### REFERENCE NUMERALS

1 main girder
2 transverse girder
3 longitudinal rib
4 deck plate
5 pavement
6 outside stringer
7 concrete
8 reinforcing steel bars
9 dislocation preventing bolt
9b stud dowel
10 upper flange
20 upper-surface transverse rib
31 through hole
70 haunch concrete
81 longitudinal reinforcing steel bar
82 transverse reinforcing steel bar
91 threaded section
91b dowel head
92 tapered section
92b dowel rod
93 cylindrical section
98 washer
99 nut
100 longitudinal rib composite floor slab (second embodiment)
200 longitudinal rib composite floor slab (third embodiment)

### BEST MODES FOR CARRYING OUT THE INVENTION

### First Embodiment

(Dislocation Preventing Bolt)

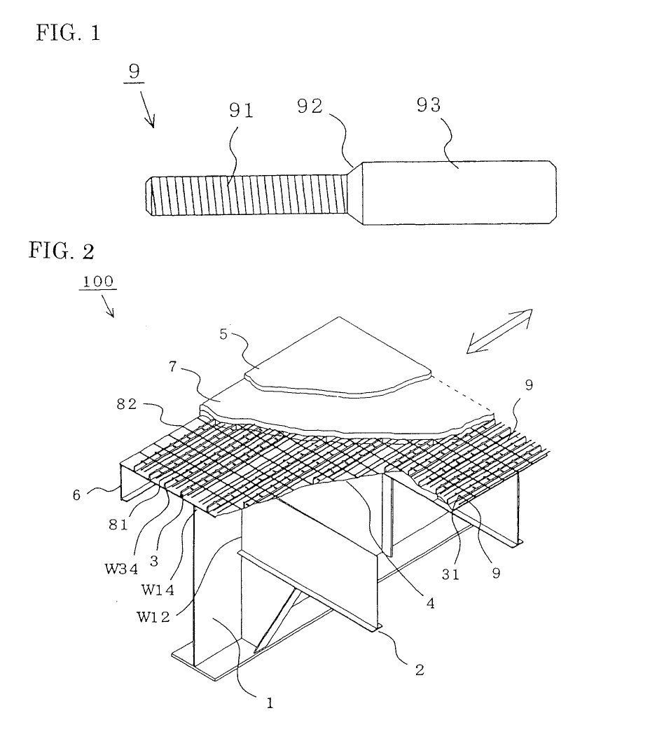

FIG. 1 is a side view of a dislocation preventing bolt according to a first embodiment of the present invention. In FIG. 1, a dislocation preventing bolt 9 has a threaded section 91, which has an external thread, a tapered section 92, which is formed continuously from the threaded section and which is gradually enlarged, and a cylindrical section 93, which is formed continuously from the tapered section.

For example, the threaded section 91 having a length of 100 mm has the M22 external thread formed thereat. The tapered section 92 has an external diameter gradually increasing from 22 mm to 25 mm in the range of the length of approximately 10 mm. The cylindrical section 93 has an external diameter of 25 mm and a length of 100 mm. A member to which this bolt is to be set is provided with, for example, a through hole having an internal diameter of 23.5 mm. If the threaded section 91 of the dislocation preventing bolt 9 is inserted into the through hole, the tapered section 92 is retained by the through hole. Here, if a nut (not shown) is screwed on the threaded section 91 through a washer, the dislocation preventing bolt 9 is easily and reliably set to this member.

In the present invention, the dimensions of the dislocation preventing bolt 9 are not limited to the aforementioned values, so that the values of the external diameters and lengths can be selected appropriately.

The threaded section 91 may be formed so that it has the external thread formed only near the tapered section 92, and a circular cylindrical shape formed in a range disposed away from the tapered section 92. It is also possible to form a small diameter portion at a boundary between the threaded section 91 and the tapered section 92, so that an incomplete thread is not formed.

The external diameter of the cylindrical section 92 is not limited to a value equal to a maximum external diameter of the tapered section 92. As long as the tapered section 92 is formed, the external diameter of the cylindrical section 93 may be less than (or greater than) the maximum external diameter of the tapered section 92. It is also possible to provide the cylindrical section 93 with an external thread to increase adhesive strength to concrete.

### Second Embodiment

(Longitudinal Rib Composite Floor Slab)

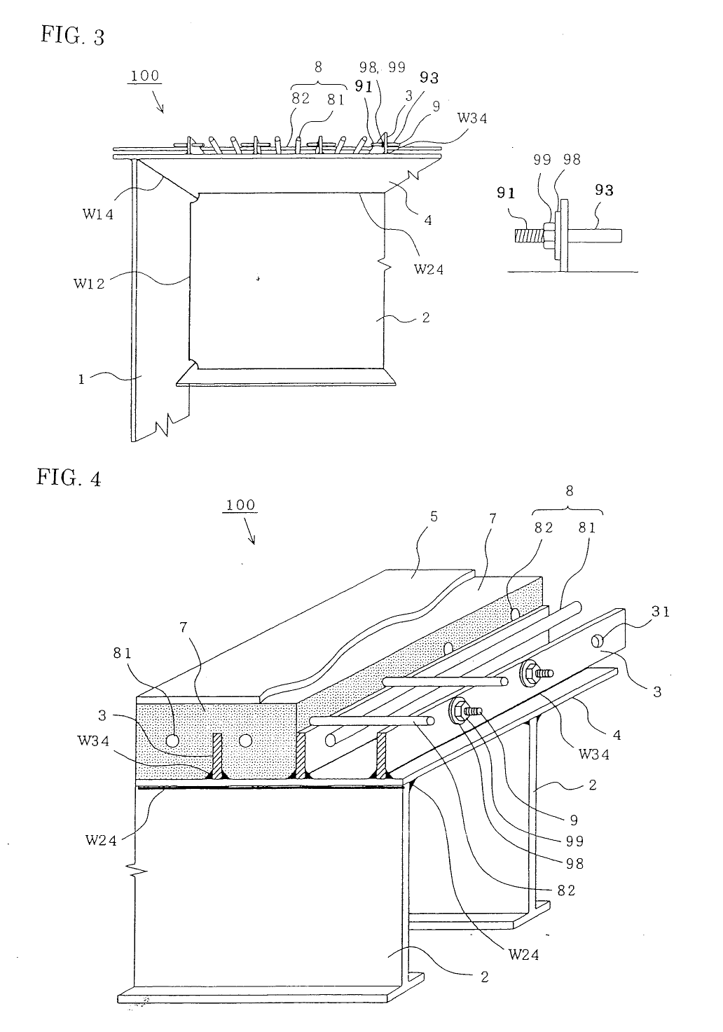

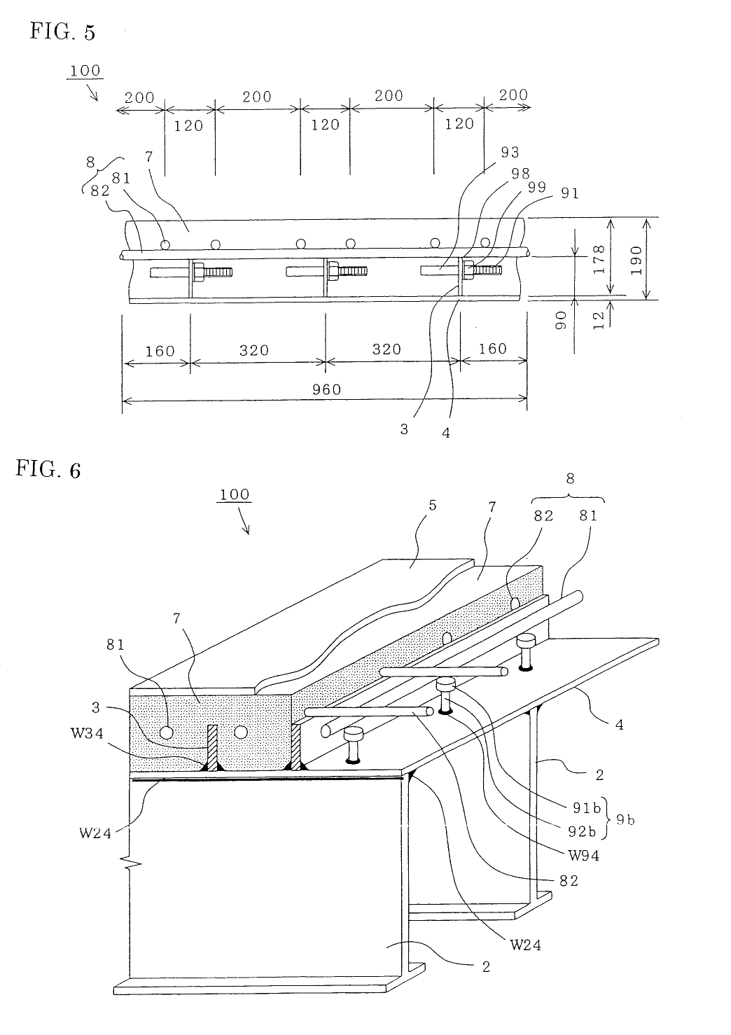

FIGS. 2 to 5 are each a schematic view of a longitudinal rib composite floor slab according to a second embodiment of the present invention. FIG. 2 is a perspective view, FIG. 3 is a partial front view, FIG. 4 is a partial enlarged view, and FIG. 5 is a partial front view showing a state in which dislocation preventing bolts are set. The same or corresponding parts to those of the background art (FIGS. 4 and 5) are given the same reference numerals, and descriptions thereof will be partly omitted.

In FIGS. 2 to 5, a longitudinal rib composite floor slab 100 comprises a main girder 1, a transverse girder 2, a deck plate 4, longitudinal ribs 3, concrete 7, and pavement 5. The main girder 1 is parallel to a bridge axis indicated by an arrow. The transverse girder 2 is perpendicular to the main girder 1 and joined to the main girder 1 (joint is indicated by a weld line W12). The lower surface side of the deck plate 4 is joined to the main girder 1 and the transverse girder 2 (joints are indicated by a weld line W14 and a weld line W24). The longitudinal ribs 3 are joined to the upper surface side of the deck plate 4 (joints are indicated by weld lines W34). The concrete 7 is placed on the upper surface side of the deck plate 4. The pavement 5 is placed on the upper surface of the concrete 7.

An outside stringer 6 that is parallel to the longitudinal ribs 3 (or parallel to the main girder 1) is provided at a side edge of the deck plate 4. The lower surface of the deck plate 4 may be only joined to the transverse girder 2, and may be only in contact with or separated from the main girder 1.

In addition, the concrete 7 has longitudinal reinforcing steel bars 81 and transverse reinforcing steel bars 82 (these together will hereunder be referred to as the “reinforcing steel bars 8”). The longitudinal ribs 3 have a plurality of through holes 31. Dislocation preventing bolts 9 are inserted into the through holes 31, and are secured by nuts 99 through washers 98 so as to be incapable of coming off (see FIG. 5).

For example, in FIG. 5, the longitudinal ribs 3 each have a thickness of 8 mm, and a width of 90 mm (which is equal to the height in the figure), and are arranged at regular intervals of 320 mm in front view. The through holes 31 having an internal diameter of 23.5 mm are formed at positions that are situated at 52.5 mm from the deck plate 4.

Threaded sections 91 (where M22 external threads having a length of 100 mm are formed) are inserted into the through holes 31, and tapered sections 92 (whose external diameter is gradually increased from 22 mm to 25 mm in a range of length of approximately 10 mm) are retained by the through holes 31. In addition, M221-type nuts 99 are screwed on the threaded sections 91 through the M22 washers 98, so that, by fastening the M221-type nuts 99, the dislocation preventing bolts 9 are easily and reliably set to the longitudinal ribs 3.

Since the cylindrical sections 93 each have an external diameter of 25 mm and a length of 100 mm, the threaded sections 91 and the cylindrical sections 93 project from respective side surfaces of the ribs 3 by a length of 100 mm, respectively. That is, the longitudinal ribs 3 are separated from each other by 320 mm, each threaded section 91 projects from a corresponding one of the longitudinal ribs 3 to the other corresponding one of the longitudinal ribs 3 by a length of 100 mm, and each circular cylindrical section 93 projects from the other corresponding one of the longitudinal ribs 3 to the corresponding one of the longitudinal ribs 3 by a length of 100 mm.

Since the longitudinal reinforcing steel bars 81 are disposed at positions that are separated by 60 mm from the longitudinal ribs 3, the longitudinal reinforcing steel bars 81 are disposed at intervals of 120 mm and 200 mm.

Since the longitudinal rib composite floor slab 100 has the above-described structure, the concrete 7 is reinforced by the reinforcing steel bars 8, and is dynamically connected to (force is transferred to) the longitudinal ribs 3 by the dislocation preventing bolts 9. The upper surface of the deck plate 4 is joined to the longitudinal ribs 3 that are perpendicular to the bridge axis, and the lower surface of the deck plate 4 is joined to the main girder 1 and the transverse girder 2 in parallel to the bridge axis. Therefore, a highly rigid composite structure is formed by the concrete 7, the deck plate 4, the longitudinal ribs 3, the transverse girder 2, and the main girder 1.

Consequently, the effect that the deck plate 4 can be included in a resistance cross section with respect to a dead/live load, and the effect that the rigidity of the longitudinal ribs 3 joined to the deck plate 4 is increased reduce the load on the main girder 1. Therefore, the reduction in weight of a superstructure work is accelerated, and a load on a lower structure is reduced. Therefore, manufacturing costs of a road and a bridge beam are reduced.

Alongside the transverse girder 2, a transverse girder having a greater beam height than the transverse girder 2 may be provided. In addition, the structure of the main girder 1 is not limited to the illustrated structure. Further, it is possible to join the main girder 1 only to the transverse girder 2, and to separate the main girder 1 from the deck plate 4.

Further, since the dislocation preventing bolts 9 are inserted into the respective through holes 31 after the longitudinal ribs 3 are joined to the deck plate 4, they do not hinder the joining operation. However, the longitudinal ribs 3 previously provided with the dislocation preventing bolts 9 may be joined to the deck plate 4. Further, the arrangement of the reinforcing steel bars 8 is not limited to the illustrated arrangement.

### Third Embodiment

(Longitudinal Rib Composite Floor Slab)

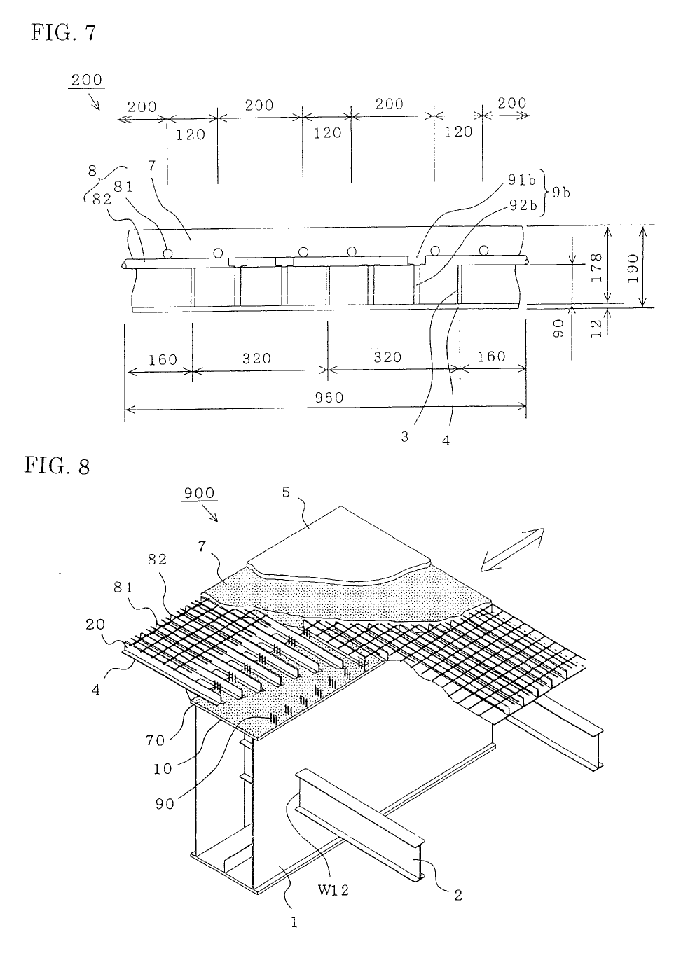

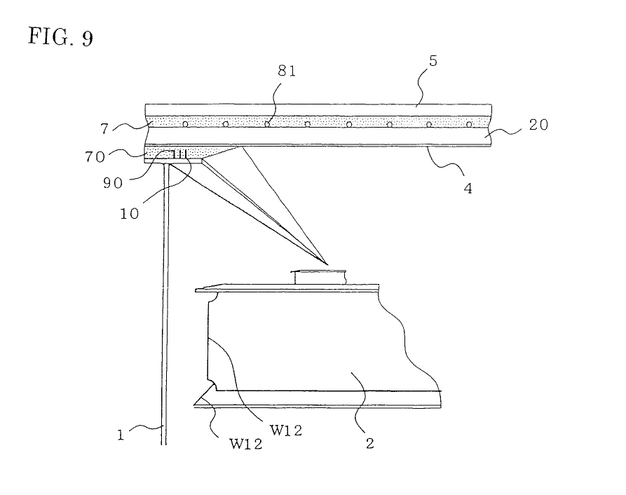

FIGS. 6 and 7 are each a schematic view of a longitudinal rib composite floor slab according to a third embodiment of the present invention. FIG. 6 is a partial enlarged view, and FIG. 7 is a partial front view showing a state in which stud dowels are set. The same or corresponding parts to those of the background art (FIGS. 4 and 5) and to the second embodiment (FIGS. 2 to 5) are given the same reference numerals, and descriptions thereof will be partly omitted.

In FIGS. 6 and 7, a longitudinal rib composite floor slab 200 is one in which stud dowels 9b are provided to a deck plate 4 instead of the dislocation preventing bolts 9 that are provided to the longitudinal ribs 3 in the longitudinal rib composite floor slab 100.

Each stud dowel 9b has a disc-shaped dowel head 91b and a cylindrical dowel rod 92b connected to the corresponding dowel head 91b. The lower end of each dowel rod 92b is welded and secured (indicated by W94) to the deck plate 4.

Therefore, in the longitudinal rib composite floor slab 200, concrete 7 is reinforced by reinforcing steel bars 8, and is dynamically connected (force is transferred) to the deck plate 4 by the stud dowels 9b. The upper surface of the deck plate 4 is joined to longitudinal ribs 3 that are perpendicular to a bridge axis, and the lower surface of the deck plate 4 is joined to a main girder 1 and a transverse girder 2 parallel to the bridge axis. Therefore, a highly rigid composite structure is formed by the concrete 7, the deck plate 4, the longitudinal ribs 3, the transverse girder 2, and the main girder 1.

Consequently, the effect that the deck plate 4 can be included in a resistance cross section with respect to a dead/live load, and the effect that the rigidity of the longitudinal ribs 3 joined to the deck plate 4 is increased reduce the load on the main girder 1. Therefore, the reduction in weight of a superstructure work is accelerated, and a load on a lower structure is reduced. Therefore, manufacturing costs of a road and a bridge beam are reduced.

In the present invention, the form and number of stud dowels 9b are not limited to those that are illustrated, so that they may be selected appropriately. For example, each dowel head 91b may be bent into an L shape instead of being formed in a disc shape. Each dowel rod 92b may be bent into a V shape instead of being formed of one circular column.

### INDUSTRIAL APPLICABILITY

According to the present invention, the structure is formed by simple members, and allows larger portions to be included in a resistance cross section with respect to a dead/live load. Therefore, the structure is widely used as a light and low-cost composite floor slab structure used in various roads and various bridge beams.

1. A dislocation preventing bolt that prevents dislocationing between concrete and a member surrounded by the concrete, the dislocation preventing bolt comprising:
a threaded section having an external thread formed thereon;
a tapered section that is formed continuously from the threaded section and that is gradually enlarged; and
a cylindrical section that is formed continuously from the tapered section.

2. A longitudinal rib composite floor slab comprising:
a main girder that is parallel to a bridge axis;
a transverse girder that is joined to the main girder and that is perpendicular to the bridge axis;
a deck plate whose lower surface side is joined to the transverse girder;
a longitudinal rib that is joined to an upper surface side of the deck plate and that is parallel to the bridge axis;
concrete that is placed on the upper surface of the deck plate; and
pavement that is placed on an upper surface of the concrete,
wherein the longitudinal rib is provided with a through hole, and
wherein the tapered section of the dislocation preventing bolt of claim 1 is retained by the through hole.

3. A longitudinal rib composite floor slab comprising:
a main girder that is parallel to a bridge axis;
a transverse girder that is joined to the main girder and that is perpendicular to the bridge axis;
a deck plate whose lower surface side is joined to the transverse girder;
a longitudinal rib that is joined to an upper surface side of the deck plate and that is parallel to the bridge axis;
concrete that is placed on the upper surface of the deck plate; and
pavement that is placed on an upper surface of the concrete,
wherein the upper surface of the deck plate is provided with a stud dowel.

4. The longitudinal rib composite floor slab according to claim 2, wherein the deck plate is joined to the main girder.

5. The longitudinal rib composite floor slab according to claim 2, wherein a side edge of the deck plate is provided with an outside stringer that is parallel to the bridge axis.

6. The longitudinal rib composite floor slab according to claim 3, wherein the deck plate is joined to the main girder.

7. The longitudinal rib composite floor slab according to claim 3, wherein a side edge of the deck plate is provided with an outside stringer that is parallel to the bridge axis.

8. The longitudinal rib composite floor slab according to claim 4, wherein a side edge of the deck plate is provided with an outside stringer that is parallel to the bridge axis.
